(19) United States
(12) Patent Application Publication
(10) Pub. No.: US 2015/0336197 A1
(43) Pub. Date: Nov. 26, 2015

(54) ENGINE DRIVE POWER SUPPLY USING HIGH SPEED FLYWHEEL

(71) Applicant: LINCOLN GLOBAL, INC., CITY OF INDUSTRY, CA (US)

(72) Inventor: Carmen DeLisio, Hudson, OH (US)

(21) Appl. No.: 14/721,955

(22) Filed: May 26, 2015

Related U.S. Application Data
(60) Provisional application No. 62/002,770, filed on May 23, 2014.

(51) Int. Cl. B23K 9/10; B23K 9/095

(52) U.S. Cl. CPC B23K 9/1006; B23K 9/095

(57) ABSTRACT

An engine driven power supply is provided which uses a high speed flywheel coupled to a transmission of the system. The high speed flywheel is brought to a high RPM rate during times of low power consumption and then releases its stored energy when the energy demand is needed allowing for the system to have the desired available power when needed. During a first mode of operation the power generator is turned by the transmission of the engine system, and in high power demand scenarios, when the engine could be idling, the power generator is turned by the flywheel.

### INCORPORATION BY REFERENCE

The present application claims priority to U.S. Provisional Patent Application No. 62/002,770 which is incorporated herein by reference in its entirety.

### TECHNICAL FIELD

Devices, systems, and methods consistent with the invention relate to the generation of power, and more specifically to devices, systems and methods for generating welding or cutting power with an engine-drive power supply.

### BACKGROUND

In areas where utility power is not available or is not reliable, engine driven welders are typically used. As the development of the engine driven welders has progressed the power requirements on the engine driven welders has become more and more complex. For example, many engine driven welders are equipped with an air compressor (often a screw-type compressor), and may also be equipped with the means to provide auxiliary power (e.g., 110 V) for various other tools or components requiring electricity. Therefore, the power demands for engine driven welders continues to increase, particularly when multiple demands are being placed on the welder at one time. That is, when air compressor and auxiliary power are being used at the same time as a welding operation the power demands can be very high. This is particularly true at the beginning of a welding (or cutting) operation. Because of this, often there is a lag in the welding/cutting power available.

Further limitations and disadvantages of conventional, traditional, and proposed approaches will become apparent to one of skill in the art, through comparison of such approaches with embodiments of the present invention as set forth in the remainder of the present application with reference to the drawings.

### BRIEF SUMMARY OF THE INVENTION

An exemplary embodiment of the present invention is an engine driven power supply using a high speed flywheel coupled to a transmission of the system. The high speed flywheel is brought to a high RPM rate during times of low power consumption and then releases its stored energy when the energy demand is needed allowing for the system to have the desired available power when needed.

### BRIEF DESCRIPTION OF THE DRAWINGS

The above and/or other aspects of the invention will be more apparent by describing in detail exemplary embodiments of the invention with reference to the accompanying drawings, in which:

FIG. 1 is a perspective view of an exemplary engine driven power supply system that may be used with one or more of the exemplary inventions described herein;

FIG. 2 is a breakout illustration of the various major sub-assemblies that are part of a system shown in FIG. 1; and

FIG. 3 is a breakout illustration similar to that shown in FIG. 2, but includes a high-speed flywheel and transmission according to an exemplary embodiment of the present invention.

### DETAILED DESCRIPTION

While the various inventions and inventive concepts are described herein with reference to specific embodiments, such illustrations and descriptions are intended to be exemplary in nature and not as the only embodiments. For example, an embodiment of an engine driven power supply is illustrated with specific examples of power generators, however, the particular design of the system and the power generators is largely a matter of design choice except as to various inventive concepts presented herein. Also, as to the inventive concepts described herein, such inventions will find application in many different types of power generation systems whether engine driven or otherwise.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

Further, for clarity and brevity the following discussion will focus on using the engine driven power supplies described herein for a welding operation. However, it is understood that embodiments of the present invention are not limited in this regarding and can also be used for cutting or other power generation applications. Therefore, the following discussions directed to welding are not intended to be limiting in any, but are merely exemplary.

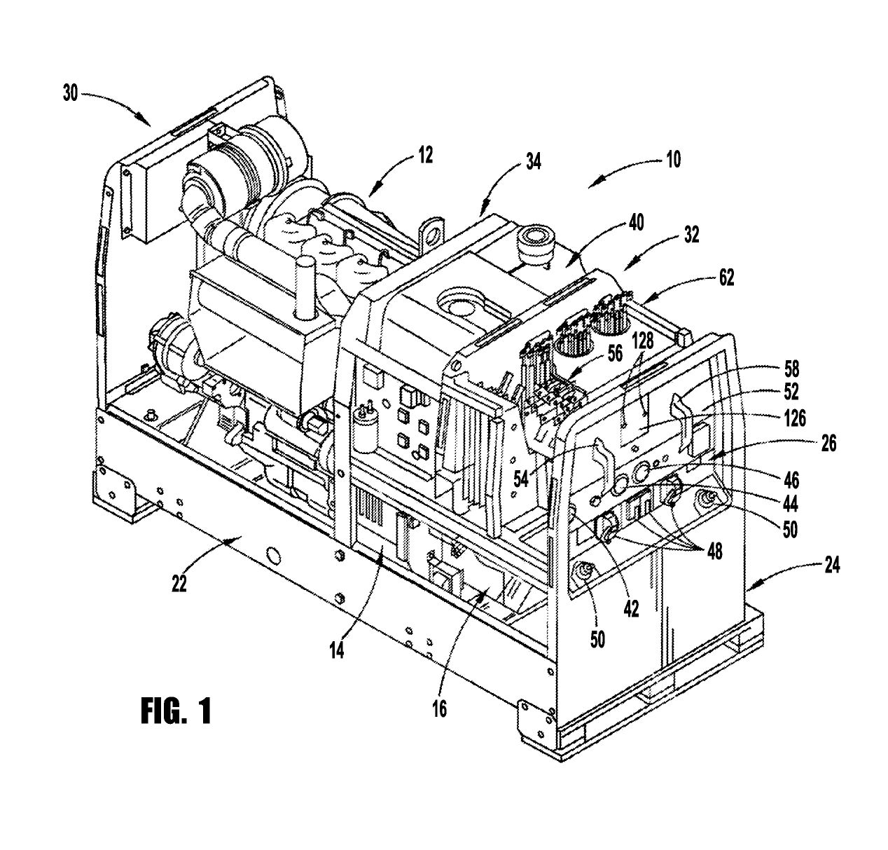

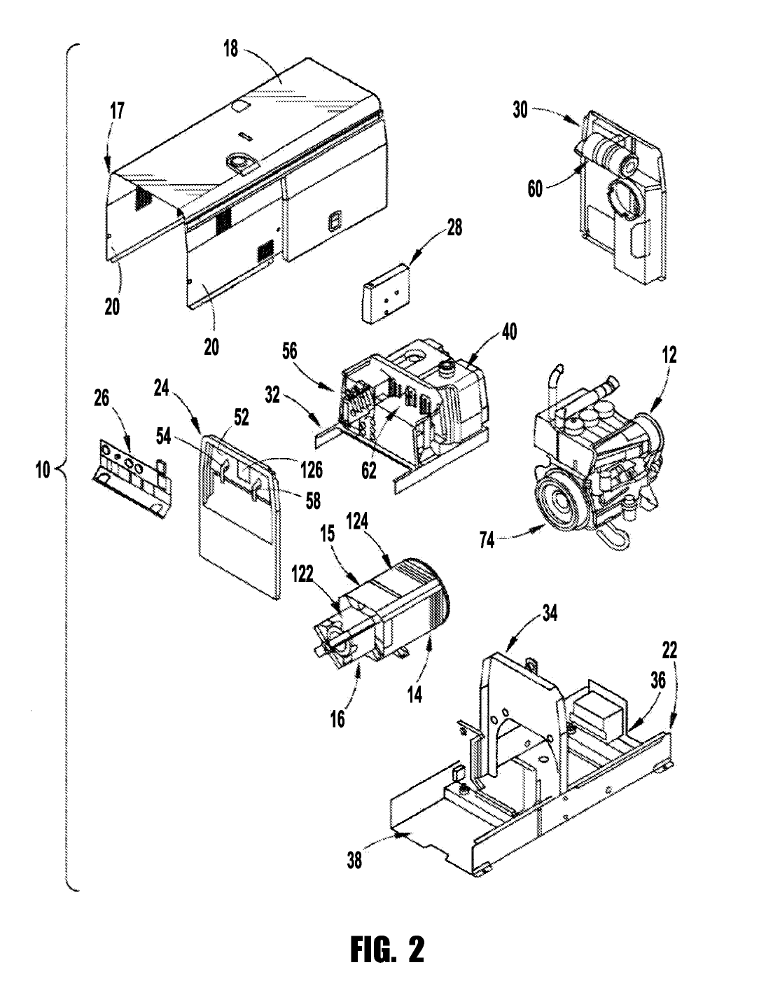

With reference to FIGS. 1 and 2, an exemplary engine driven power supply system 10 is illustrated, and such a system 10 may incorporate any one or more or all of the inventions described herein. The specifics of the overall system 10, including the engine 12 and power generators 14, 16 (the latter not fully visible in the view of FIG. 1) are not restrictive as to the nature and use of the inventions presented herein. Rather, many different types of engines, including diesel and gas powered of various sizes and designs, and many different power generators, may be used as a welding system suitable for use with the inventions herein. Moreover, some of the inventions herein will find application outside of the art of engine driven welding systems to welding system power supplies in general.

A cover assembly 17 may include a roof 18 and various side casings 20 (FIG. 2), typically made of sheet metal, and is omitted from FIG. 1 to illustrate the overall assembly of the engine driven welding system 10. The major subassemblies may include a support base 22, the engine 12, a generator assembly 15 that includes in this example two power generators 14, 16, a case front and upper control panel assembly 24, a lower control panel 26, an inner control panel 28, a case back assembly 30 and a reactor, rectifier and fuel tank assembly 32. The support base 22 may include a lift frame 34.

The engine 12 may be mounted in a rearward portion 36 of the support base 22, and the generator assembly 15 may be mounted in a forward portion 38 of the support base 22. The reactor, rectifier and fuel tank assembly 32 may be mounted generally above the generator assembly 15, and supported by the lift frame 34 and the case front 24. This positions the fuel tank 40 in a convenient location for the user. The generator assembly 15 is generally aligned with the drive mechanism of the engine 12 as will be more apparent from the below discussion.

The lower control panel assembly 26 may include various components that facilitate the use and control of the welding system 10, for example, a fuel/hour gage 42, oil temperature and pressure gages 44, 46 and various electrical receptacles 48, and output terminals 50. An upper control panel 52 may include various control handles for manual actuation, for example, a first control handle 54 that may be used to select the output from the engine power supply (the welder power supply produces one or more current/voltage power outputs based on the power generated by the power generator). The first control handle 54 in this example is used to manually rotate a rotary power switch 56 that is mounted on the reactor, rectifier and fuel tank assembly 32 (the reactor and rectifier assembly are major components of the welding power supply). A second control handle 58 may be used, for example, to operate a rotary rheostat (not shown) mounted on the interior side of the case front 24 opposite the second control handle 58. The case back 30 may support, for example, an air cleaner 60 for the engine 12.

Various electrical cables 62 (illustrated in a non-connected condition) are used to connect the three phase weld stator windings to the reactor (not shown in detail in FIG. 2) via the rotary power switch 56. In this exemplary embodiment, the power generator produces a three phase output with various taps so that different outputs can be selected using the rotary power switch 56 (for example, different voltage and current outputs). Many different weld power generators may be used beyond three phase, and also may provide different numbers of taps for different output options.

In the exemplary embodiments herein, two power generators 14, 16 are used. The first power generator 14 may be, for example, a weld generator, and the second power generator 16 may be an auxiliary power generator such as may be used for auxiliary power tools and so on. However, the inventions herein may be used with welding systems that provide two weld power generators, two auxiliary generators and so on.

Further, although not shown in FIGS. 1 and 2, the system 10 can also include an air compressor. For example, a screw-type air compressor can be coupled to the engine to generate compressed air for various applications. The construction, operation and incorporation of air compressors into engine driven power supplies is well known to those of skill in the art and need not be discussed further in detail herein.

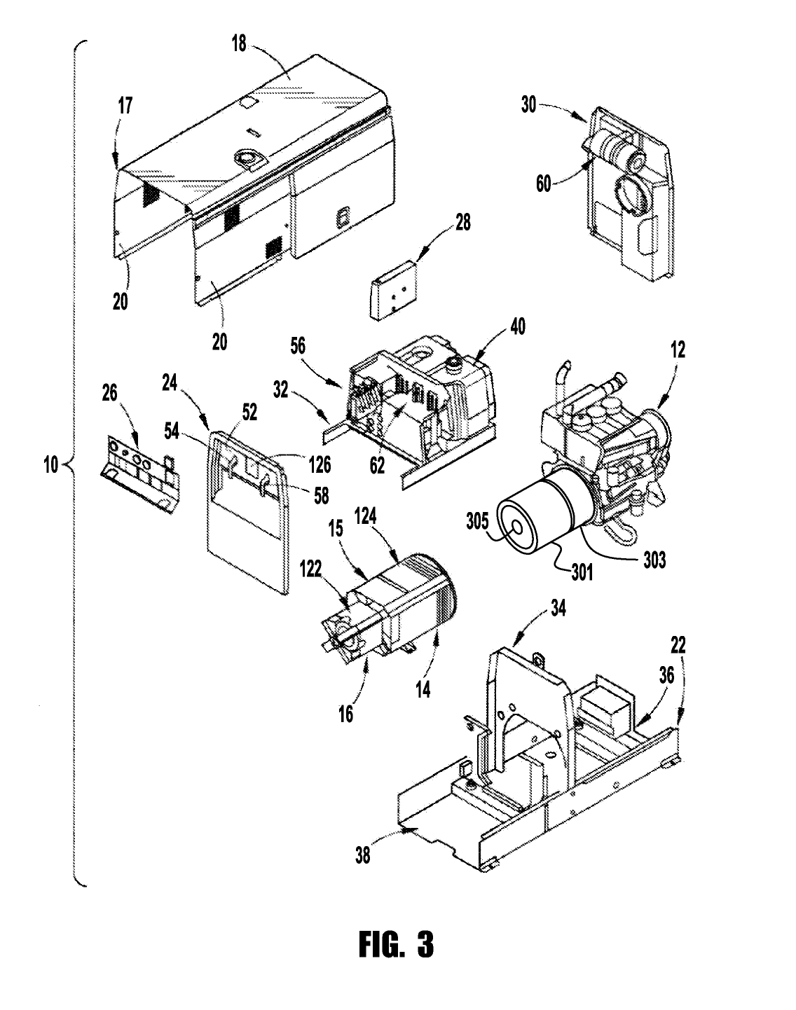

FIG. 3 is similar to what is shown in FIG. 2 except that a transmission 303 and high-speed flywheel 301 of the present invention is depicted. The flywheel 301 is coupled to a drive shaft 305 which spins the flywheel. As explained previously, with existing engine drive power supplies, there can be periods during operation where the demand for power is too much, particularly during welding/cutting start up. Embodiments of the present invention address this issue by utilizing a high-speed flywheel 301 which stores energy due to its rotation. The flywheel 301, through the transmission 303 can be brought up to speed very quickly during periods of usage where the overall power demands are low. Then, once high power demands are experienced—such as during welding start up—the flywheel 301 energy is released to the generator(s) 14/16. As the energy from the flywheel 301 is released the engine can be brought up to the required speed/energy output for the welding operation. Therefore, with embodiments of the present invention, power can be made more readily available when needed—without having to wait for the engine RPMs to increase to a needed level.

In exemplary embodiments of the present invention, the flywheel 301 has a moment of inertia about its central axis sufficient to provide the desired energy and momentum, and can spin as high at high RPM rates—that is rates, much higher than current engine driven welders. In exemplary embodiments of the present invention, when the power demand of the power supply is below a first threshold of its maximum output the transmission 303 and engine 12 spin the flywheel 301 at a first rate range, and when it is above this threshold the flywheel spins within a second rate range. With the flywheel 301 spinning in the appropriate rate range, when a high demand of power is needed the energy for the generator(s) 14/16 can come from the flywheel 301 before the engine 12 gets up to speed. This allows the system 10 to be able to provide near instantaneous power at nearly all operational times.

The transmission 303 can be constructed and controlled similar to known transmissions, so long as the transmission 303 is capable of getting the flywheel 301 to the rotational speeds.

During operation, when power demand is less than the maximum amount, for example in a first range below the maximum power output of the system 10, the transmission 303 causes the flywheel 301 to spin to a high level of RPMs to store energy. For example, the flywheel 301 can be spun at a rate first rate range in RPMs. This power consumption can be due to use of an auxiliary power circuit on the system 10 and an air compressor coupled to the engine 12. When the demand for energy increases, such as at the beginning of a welding/cutting operation, the transmission 303 disengages a clutch, allowing the flywheel to spin freely—and a new clutch engages the flywheel 301 with the generator(s) 14/16 causing the generator(s) 14/16 to spin at a high rate which provides the needed energy fort whatever demands are being placed on the system 10. Then, when the power demand drops or otherwise reaches a level that can be readily supplied by the engine 12 (for example, after the engine picks up speed), the flywheel 301 can be disengaged and the generator(s) 14/16 can be turned by the engine 12.

In some exemplary embodiments of the present invention, the system 10 has a computer or processing system which monitors the ramp rate of the power being demanded by the system 10 and controls the use and operation of the flywheel 301 based on this information. As is generally known, engine driven welders using central processors, etc. to control the operation of the system 10. Because this is so well known the use and operation of controllers with engine-drive welders will not be discussed in detail herein. In embodiments of the present invention, controller(s) of the system 10 monitors the ramp rate of the power demand on the system 10 to determine whether or not the flywheel 301 power is needed. For example, the controller (not shown) can have a preset power demand ramp rate above which the flywheel 301 energy will be used, whereas below the threshold the flywheel 301 energy will not be used. For example, for some power demands on the system 10 the ramp up rate of the engine 12 is acceptable and as such the use of the flywheel 301 energy is not needed. Thus, when below the ramp rate threshold the system 10 will operate as known engine driven power supplies, whereas above the threshold the system 10 will operate as described above.

In additional exemplary embodiments, the control panel of the system 10 has a user switch which disengages the operation of the flywheel 301 as described above. This allows the user to disengage this functionality if it is determined that it will not be needed.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiment disclosed, but that the claimed subject matter will include all embodiments falling within the scope of the appended claims.

What is claimed is:

1. A engine drive welding system, comprising:
an internal combustion engine system having a transmission;
a flywheel couplable to said transmission via a first clutch; and
at least one power generator which generates an output power based on a rotation of said at least one power generator and where said at least one power generator is couplable to said flywheel via a second clutch;
wherein during a first mode of operation, said first clutch is engaged to couple said flywheel with said transmission and said second clutch is not engaged, and a rotational speed of said at least one power generator is determined by said transmission, and
wherein during a second mode of operation said first clutch is disengaged to decouple said flywheel and said transmission and said second clutch is engaged to couple said flywheel and said at least one power generator and the rotational speed of said at least one power generator is determined by said flywheel.

2. The engine drive welder of claim 1, wherein the control of the operation of said first and second clutches is based on a determined power ramp rate for an output of said engine drive welder.
